(19) United States
(12) Patent Application Publication
(10) Pub. No.: US 2011/0252332 A1
(43) Pub. Date: Oct. 13, 2011

(54) ELECTRONIC DEVICE AND METHOD FOR BROWSING INTERNET CONTENT UTILIZED THEREBY

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/953,338

(22) Filed: Nov. 23, 2010

(30) Foreign Application Priority Data
Apr. 7, 2010 (TW) 99110813

(51) Int. Cl. G06F 3/00

(52) U.S. Cl. 715/741

(57) ABSTRACT

In a method of browsing internet content using an electronic device, an image of a user is captured, a facial region from the captured image is examined, and facial characteristics are extracted from the facial region. An age of the user is estimated according to the extracted facial characteristics, and a privilege level for browsing the internet content of the user is determined accordingly. Additionally, category information of internet content of a webpage is acquired when the user opens the webpage to determine whether the user is permitted to browse the internet content, and a notification is displayed on a display screen of the electronic device to inform the user that the internet content is forbidden if the user is not permitted to browse the internet content.

### BACKGROUND

1. Technical Field

Embodiments of the present disclosure relate generally to information management systems and methods, and more particularly, to a management system and method for browsing internet content using an electronic device.

2. Description of Related Art

Many people browse internet content using electronic devices. For example, many people read news, electronic magazines, pictures, novels, and videos on the Internet using web browsers of computers, notebooks, mobile phones, or personal digital assistants (PDAs). However, some content, including images, text, and multimedia may involve violence or pornography and are not suitable for some users, such as minors.

### BRIEF DESCRIPTION OF THE DRAWINGS

FIG. 1 is a block diagram of one embodiment of an electronic device.

FIG. 2 is a schematic diagram illustrating an example of a display of the electronic device.

FIG. 3 is a flowchart of one embodiment of a method for browsing internet content using the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

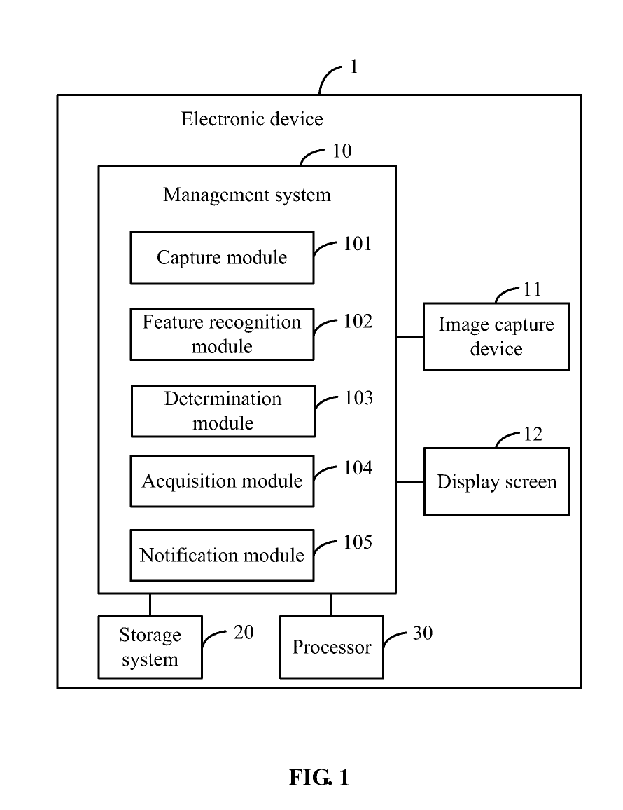

FIG. 1 is a block diagram of one embodiment of an electronic device 1. In the embodiment, the electronic device 1 includes a management system 10, an image capture device 11, a display screen 12, a storage system 20, and a processor 30. In some embodiments, the electronic device 1 may be a computer, a notebook, a mobile phone, a personal digital assistant (PDA), or any other electronic device that can be used to browse internet content. The internet content may be, for example, news, electronic magazines, pictures, novels, or videos from internet. It should be apparent that FIG. 1 is only one example of architecture of the electronic device 1 that can be included with more or fewer components than shown in other embodiments, or a different configuration of the various components.

In one embodiment, the image capture device 11 is included in the electronic device 1. In some embodiments, the image capture device 11 may be a video camera, or a digital camera, for example. The image capture device 11 is operable to capture images of a user when the user browses internet content using the electronic device 1, and send the captured images to the management system 10 to analyze. Detail of analyzing the images are provided below. In other embodiments, the image capture device 11 may be electronically or wirelessly connected to the electronic device 1 instead of being included in the electronic device 1.

The storage system 20 stores one or more programs, such as programs of an operating system, and other applications of the electronic device 1. In one embodiment, the storage system 20 may be random access memory (RAM) for temporary storage of information, and/or a read only memory (ROM) for permanent storage of information. In other embodiments, the storage system 20 may also be an external storage device, such as a hard disk, a storage card, or a data storage medium. The processor 30 executes one or more computerized operations of the electronic device 1 and other applications, to provide functions of the electronic device 1.

The management system 10 may include a plurality of functional modules comprising one or more computerized instructions that are stored in the storage system 20 or a computer-readable medium of the electronic device 1, and executed by the processor 30 to perform operations of the electronic device 1. In one embodiment, the management system 10 includes a capture module 101, a feature recognition module 102, a determination module 103, an acquisition module 104, and a notification module 105. In general, the word “module”, as used herein, refers to logic embodied in hardware or firmware, or to a collection of software instructions, written in a programming language, such as, Java, C, or Assembly. One or more software instructions in the modules may be embedded in firmware, such as EPROM. The modules described herein may be implemented as either software and/or hardware modules and may be stored in any type of computer-readable medium or other storage device.

The capture module 101 is operable to capture an image of a user using the capture device 11 when a web browser of the electronic device 1 is activated by the user. The web browser may be a Green-Browser (GB) or any other kind of web browsers installed on the electronic device 1.

The feature recognition module 102 examines a facial region from the captured image, and extracts facial characteristics from the facial region. The feature recognition module 102 uses well known feature recognition technology to examine the facial region from the captured image. For example, the feature recognition module 102 may use linear discriminate analysis technology, Hidden Markov Model technology, or neuronal motivated dynamic link matching technology to examine the facial region. The extracted facial characteristics may be, for example, facial skin textures and colors, eye contours, and nose, chin, and mouth characteristics.

The determination module 103 estimates an age of the user according to the extracted facial characteristics, and determines a privilege level for browsing the internet content for the user according to the estimated age. Details of how the determination module 103 estimates the age of the user is provided below.

In one embodiment, the determination module 103 may use a statistics method, a classification method, or a model training method to estimate the age of the user. For example, the determination module 103 may compare the extracted facial characteristics with a plurality of pre-collected standard facial characteristics of people of various ages, and determine an age of which the standard facial characteristics match with or are similar with the extracted facial characteristics as the estimated age of the user. The pre-collected standard facial characteristics of the people of various ages may be prestored in the storage system 20.

The privilege level for browsing the internet content of the user may be determined according to categories of the internet content. For example, the internet content may include two categories, such as, restriction content and normal content. The restriction content may involve material unsuited to users under eighteen. Therefore, privilege levels of browsing the internet content may comprise high privilege levels and normal privilege levels. The user over eighteen may have a high privilege level, and the age of a user under eighteen may have a low privilege level. In the embodiment, if the user has the high privilege level, the user is permitted to browse all of the internet content comprising the restriction content and the normal content. If the user has the normal privilege level, the user is permitted to browse the normal content but is forbidden to browse the restriction content. Therefore, the determination module 103 may determine a privilege level for the user by determining whether the user is over eighteen. If the user is over eighteen, the determination module 103 determines the user has a high privilege level. If the user is not over eighteen, the determination module 103 determines the user has a normal privilege level. In other embodiments, the privilege levels for browsing the internet content may comprise other sorts of privilege levels according to the categories of the internet content.

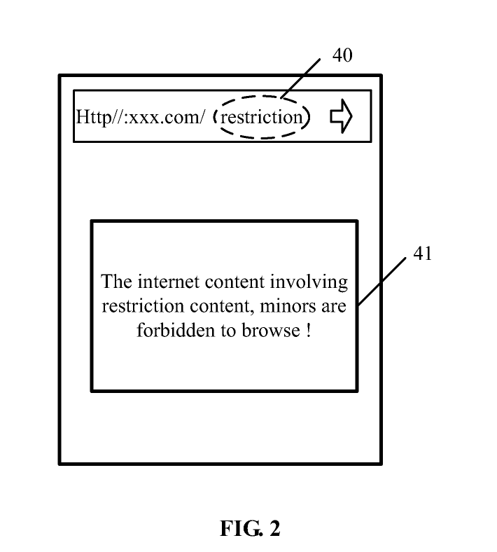

The acquisition module 104 acquires category information of internet content of a webpage when the user opens the webpage through the web browser of the electronic device 1, and determines whether the user is permitted to browse the internet content according to the acquired category information and the privilege level for browsing the internet content of the user. The category information may be marked in a determined place of the webpage by a web manager or a relevant response department. As respect in FIG. 2, the category information (e.g., “restriction”) is marked in an address bar of the webpage. The category information “restriction” 40 denotes that the internet content of the webpage is forbidden by the users who have the normal privilege levels. Additionally, the user have the high privilege level or the normal privilege level is permitted to browse the internet content of the webpage if the acquisition module 104 does not acquire any category information from the webpage.

The notification module 105 displays a notification on the display screen 12 to inform the user that the internet content of the webpage is forbidden and controls the electronic device 1 to close the webpage, if the user is not permitted to browse the internet content. In one example with the respect to FIG. 2, the notification module 105 may generate a dialog box 41 on the display screen 12 for displaying the notification to inform the user that the internet content of the webpage is forbidden.

The acquisition module 104 controls the electronic device 1 to display the internet content of the webpage on the display screen 12 if the user is permitted to browse the internet content.

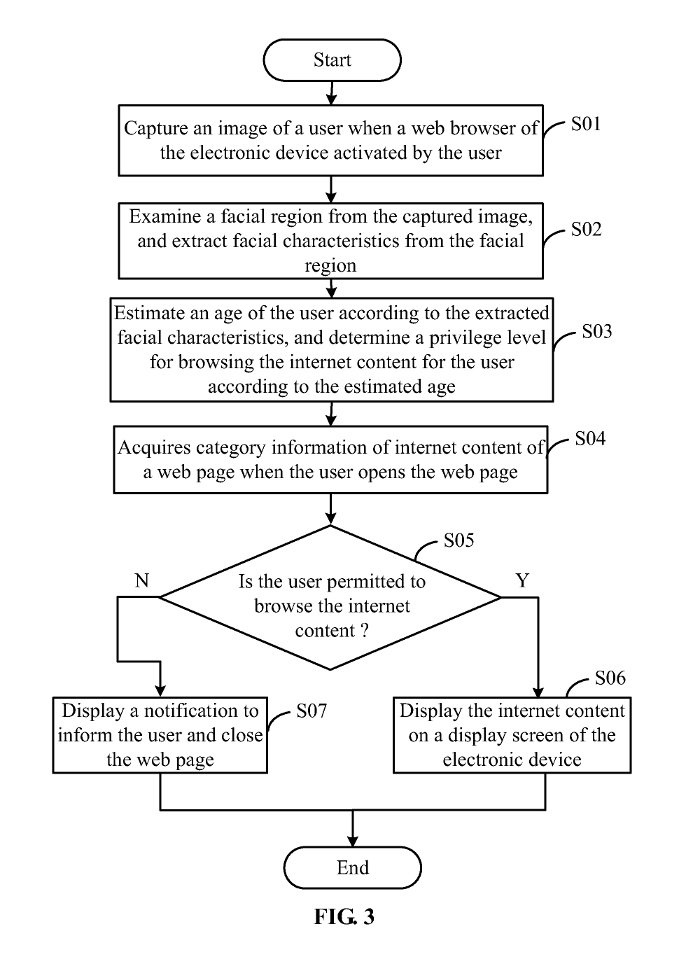

FIG. 3 is a flowchart of one embodiment of a method for browsing internet content using the electronic device 1 of FIG. 1. Depending on the embodiment, additional blocks may be added, others removed, and the ordering of the blocks, may be changed.

In block S01, the capture module 101 captures an image of a user using the capture device 11 when a web browser of the electronic device 1 is activated by a user. The web browser may be a Green-Browser (GB) or any other kind of web browsers installed on the electronic device 1.

In block S02, the feature recognition module 102 examines a facial region from the captured image, and extracts facial characteristics from the facial region. The facial region may be examined by using well known feature recognition technology as described above. The extracted facial characteristics may be, for example, facial skin textures and colors, eye contours, nose, chin, and mouth characteristics.

In block S03, the determination module 103 estimates an age of the user according to the extracted facial characteristics, and determines a privilege level for browsing the internet content for the user according to the estimated age. The age of the user may be estimated and the privilege level of the user may be determined as described above.

In block S04, the acquisition module 104 acquires category information of internet content of a webpage when the user opens the webpage through the web browser of the electronic device 1.

In block S05, the acquisition module 104 determines whether the user is permitted to browse the internet content of the webpage according to the acquired category information and the privilege level of the user. If the user is permitted to browse the internet content, block S06 is implemented, otherwise, if the user is not permitted to browse the internet content, block S07 is implemented.

In block S06, the acquisition module 104 controls the electronic device 1 to display the internet content of the webpage on the display screen 12, and the procedure ends.

In block S07, the notification module 105 displays a notification on the display screen 12 to notify the user that the internet content of the webpage is forbidden, and controls the electronic device 1 to close the webpage. In one example with respect to FIG. 2, the notification module 105 may generate a dialog box on the display screen 12 for displaying the notification to inform the user that the internet content of the webpage is forbidden.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method for browsing internet content using an electronic device, the method comprising:
capturing an image of a user using a capture device of the electronic device when a web browser of the electronic device is activated by the user;
examining a facial region from the captured image, and extracting facial characteristics from the facial region;
estimating an age of the user according to the extracted facial characteristics;
determining a privilege level for browsing the internet content for the user according to the estimated age;
acquiring category information of internet content of a webpage when the user opens the webpage through the web browser of the electronic device;
determining whether the user is permitted to browse the internet content according to the acquired category information and the privilege level of the user; and
displaying a notification on a display screen of the electronic device to inform the user that the internet content of the webpage is forbidden if the user is not permitted to browse the internet content; and
controlling the electronic device to close the webpage.

2. The method according to claim 1, further comprising:
controlling the electronic device to display the internet content of the webpage on the display screen if the user is permitted to browse the internet content.

3. The method according to claim 1, wherein the displaying step comprises:
generating a dialog box on the display screen for displaying the notification to inform the user the internet content of the webpage is forbidden.

4. The method according to claim 1, wherein the estimating step comprises:
comparing the extracted facial characteristics with a plurality of pre-collected standard facial characteristics of people of various ages; and
determining an age of which the standard facial characteristics match with or are similar with the extracted facial characteristics as the estimated age of the user.

5. The method according to claim 1, wherein the step of determining a privilege level for browsing the internet content for the user comprises:
determining whether the estimated age of the user is over eighteen;
determining the user has a high privilege level if the estimated age of the user is over eighteen; or
determining the user has a normal privilege level if the estimated age of the user is not over eighteen.

6. The method according to claim 5, wherein the internet content comprise restriction content that is permitted to be browsed by the user having the high privilege level, and normal content that is permitted to be browsed by both the user having the high privilege level and the user having the normal privilege level.

7. An electronic device, comprising:
a storage system;
at least one processor; and
one or more programs stored in the storage system and being executable by the at least one processor, the one or more programs comprising:
a capture module operable to capture an image of a user using a capture device of the electronic device when a web browser of the electronic device is activated by the user;
a feature recognition module operable to examine a facial region from the captured image, and extracts facial characteristics from the facial region;
a determination module operable to estimate an age of the user according to the extracted facial characteristics, and determine a privilege level for browsing internet content for the user according to the estimated age;
an acquisition module operable to acquire category information of internet content of a webpage when the user opens the webpage through the web browser, and determine whether the user is permitted to browse the internet content according to the acquired category information and the privilege level of the user; and
a notification module operable to display a notification on a display screen of the electronic device to inform the user that the internet content of the webpage is forbidden and control the electronic device to close the webpage, if the user is not permitted to browse the internet content.

8. The electronic device according to claim 7, wherein the acquisition module further operable to control the electronic device to display the internet content of the webpage on a display screen of the electronic device if the user is permitted to browse the internet content.

9. The electronic device according to claim 6, wherein the notification module is further operable to generate a dialog box on the display screen for displaying the notification to inform the user the internet content of the webpage is forbidden.

10. The electronic device according to claim 7, wherein the determination module is further operable to compare the extracted facial characteristics with a plurality of pre-collected standard facial characteristics of people of various ages, and determine an age of which the standard facial characteristics match with or are similar with the extracted facial characteristics as the estimated age of the user.

11. The electronic device according to claim 7, wherein the determination module is further operable to determine whether the estimated age of the user is over eighteen, and if the estimated age of the user is over eighteen determine the user has a high privilege level, or determine the user has a normal privilege level if estimated age of the user is not over eighteen.

12. The electronic device according to claim 10, wherein the internet content comprise restriction content that is permitted to be browsed by the user having the high privilege level, and normal content that is permitted to be browsed by both the user having the high privilege level and the user having the normal privilege level.

13. A storage medium storing a set of instructions, the set of instructions capable of being executed by a processor of an electronic device, causing the electronic device to perform a method for browsing internet content, the method comprising:
capturing an image of a user using a capture device of the electronic device when a web browser of the electronic device is activated by the user;
examining a facial region from the captured image, and extracts facial characteristics from the facial region;
estimating an age of the user according to the extracted facial characteristics;
determining a privilege level for browsing the internet content for the user according to the estimated age;
acquiring category information of internet content of a webpage when the user opens the webpage through the web browser of the electronic device;
determining whether the user is permitted to browse the internet content according to the acquired category information and the privilege level of the user; and
displaying a notification on a display screen of the electronic device to inform the user that the internet content of the webpage is forbidden if the user is not permitted to browse the internet content; and
controlling the electronic device to close the webpage.

14. The storage medium as claimed in claim 13, wherein the method further comprises:
controlling the electronic device to display the internet content of the webpage on a display screen of the electronic device if the user is permitted to browse the internet content.

15. The storage medium as claimed in claim 13, wherein the generating step comprises:
generating a dialog box on the display screen for displaying the notification to inform the user the internet content of the webpage is forbidden.

16. The storage medium as claimed in claim 13, wherein the estimating step comprises:
comparing the extracted facial characteristics with a plurality of pre-collected standard facial characteristics of people of various ages; and
determining an age of which the standard facial characteristics match with or are similar with the extracted facial characteristics as the estimated age of the user.

17. The storage medium as claimed in claim 13, wherein the step of determining a privilege level for browsing the internet content for the user comprises:
determining whether the estimated age of the user is over eighteen;
determining the user has a high privilege level if the estimated age of the user is over eighteen; or
determining the user has a normal privilege level if the age of the estimated age of the user is not over eighteen.

18. The storage medium as claimed in claim 13, wherein the internet content comprise restriction content that is permitted to be browsed by the user having the high privilege level, and normal content that is permitted to be browsed by both the user having the high privilege level and the user having the normal privilege level.
